(19) United States
(12) Patent Application Publication
(10) Pub. No.: US 2025/0048405 A1
(43) Pub. Date: Feb. 6, 2025

(54) SIDELINK COMMUNICATION CARRIER AGGREGATION

(71) Applicant: QUALCOMM Incorporated, San Diego, CA (US)

(72) Inventors: Sourjya DUTTA, San Diego, CA (US); Jae Ho RYU, San Diego, CA (US); Gabi SARKIS, San Diego, CA (US)

(21) Appl. No.: 18/790,553

(22) Filed: Jul. 31, 2024

Related U.S. Application Data
(60) Provisional application No. 63/517,802, filed on Aug. 4, 2023.

(51) Int. Cl. H04W 72/40; H04L 5/00; H04W 92/18

(52) U.S. Cl. CPC H04W 72/40; H04L 5/001; H04W 92/18

(57) ABSTRACT

Various aspects of the present disclosure generally relate to wireless communication. In some aspects, a user equipment (UE) may obtain configuration information associated with a sidelink communication, the configuration information indicating that each physical sidelink feedback channel (PSFCH) resource of a plurality of PSFCH resources associated with a carrier aggregation operation is to have a same time domain location across all component carriers of a plurality of component carriers, and indicating that each bandwidth part of a plurality of bandwidth parts associated with the carrier aggregation operation is to be configured with a same sidelink symbol length and a same sidelink start symbol. The UE may transmit or receive a sidelink communication in accordance with the configuration information. Numerous other aspects are described.

### CROSS-REFERENCE TO RELATED APPLICATION

This patent application claims priority to U.S. Provisional Patent Application No. 63/517,802, filed on Aug. 4, 2023, entitled “SIDELINK COMMUNICATION CARRIER AGGREGATION,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for sidelink communication carrier aggregation.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a transmitting user equipment (UE). The method may include obtaining configuration information associated with a sidelink communication, the configuration information indicating that each physical sidelink feedback channel (PSFCH) resource of a plurality of PSFCH resources associated with a carrier aggregation operation is to have a same time domain location across all component carriers of a plurality of component carriers, and indicating that each bandwidth part of a plurality of bandwidth parts associated with the carrier aggregation operation is to be configured with a same sidelink symbol length and a same sidelink start symbol. The method may include transmitting, to a receiving UE, a sidelink communication in accordance with the configuration information.

Some aspects described herein relate to a method of wireless communication performed by a receiving UE. The method may include obtaining configuration information associated with a sidelink communication, the configuration information indicating that each PSFCH resource of a plurality of PSFCH resources associated with a carrier aggregation operation is to have a same time domain location across all component carriers of a plurality of component carriers, and indicating that each bandwidth part of a plurality of bandwidth parts associated with the carrier aggregation operation is to be configured with a same sidelink symbol length and a same sidelink start symbol. The method may include receiving, from a transmitting UE, a sidelink communication in accordance with the configuration information.

Some aspects described herein relate to a transmitting UE for wireless communication. The transmitting UE may include one or more memories and one or more processors coupled to the one or more memories. The one or more processors may be configured to obtain configuration information associated with a sidelink communication, the configuration information indicating that each PSFCH resource of a plurality of PSFCH resources associated with a carrier aggregation operation is to have a same time domain location across all component carriers of a plurality of component carriers, and indicating that each bandwidth part of a plurality of bandwidth parts associated with the carrier aggregation operation is to be configured with a same sidelink symbol length and a same sidelink start symbol. The one or more processors may be configured to transmit, to a receiving UE, a sidelink communication in accordance with the configuration information.

Some aspects described herein relate to a receiving UE for wireless communication. The receiving UE may include one or more memories and one or more processors coupled to the one or more memories. The one or more processors may be configured to obtain configuration information associated with a sidelink communication, the configuration information indicating that each PSFCH resource of a plurality of PSFCH resources associated with a carrier aggregation operation is to have a same time domain location across all component carriers of a plurality of component carriers, and indicating that each bandwidth part of a plurality of bandwidth parts associated with the carrier aggregation operation is to be configured with a same sidelink symbol length and a same sidelink start symbol. The one or more processors may be configured to receive, from a transmitting UE, a sidelink communication in accordance with the configuration information.

Some aspects described herein relate to a non-transitory computer-readable medium that stores a set of instructions for wireless communication by a transmitting UE. The set of instructions, when executed by one or more processors of the transmitting UE, may cause the transmitting UE to obtain configuration information associated with a sidelink communication, the configuration information indicating that each PSFCH resource of a plurality of PSFCH resources associated with a carrier aggregation operation is to have a same time domain location across all component carriers of a plurality of component carriers, and indicating that each bandwidth part of a plurality of bandwidth parts associated with the carrier aggregation operation is to be configured with a same sidelink symbol length and a same sidelink start symbol. The set of instructions, when executed by one or more processors of the transmitting UE, may cause the transmitting UE to transmit, to a receiving UE, a sidelink communication in accordance with the configuration information.

Some aspects described herein relate to a non-transitory computer-readable medium that stores a set of instructions for wireless communication by a receiving UE. The set of instructions, when executed by one or more processors of the receiving UE, may cause the receiving UE to obtain configuration information associated with a sidelink communication, the configuration information indicating that each PSFCH resource of a plurality of PSFCH resources associated with a carrier aggregation operation is to have a same time domain location across all component carriers of a plurality of component carriers, and indicating that each bandwidth part of a plurality of bandwidth parts associated with the carrier aggregation operation is to be configured with a same sidelink symbol length and a same sidelink start symbol. The set of instructions, when executed by one or more processors of the receiving UE, may cause the receiving UE to receive, from a transmitting UE, a sidelink communication in accordance with the configuration information.

Some aspects described herein relate to an apparatus for wireless communication. The apparatus may include means for obtaining configuration information associated with a sidelink communication, the configuration information indicating that each PSFCH resource of a plurality of PSFCH resources associated with a carrier aggregation operation is to have a same time domain location across all component carriers of a plurality of component carriers, and indicating that each bandwidth part of a plurality of bandwidth parts associated with the carrier aggregation operation is to be configured with a same sidelink symbol length and a same sidelink start symbol. The apparatus may include means for transmitting, to a receiving UE, a sidelink communication in accordance with the configuration information.

Some aspects described herein relate to an apparatus for wireless communication. The apparatus may include means for obtaining configuration information associated with a sidelink communication, the configuration information indicating that each PSFCH resource of a plurality of PSFCH resources associated with a carrier aggregation operation is to have a same time domain location across all component carriers of a plurality of component carriers, and indicating that each bandwidth part of a plurality of bandwidth parts associated with the carrier aggregation operation is to be configured with a same sidelink symbol length and a same sidelink start symbol. The apparatus may include means for receiving, from a transmitting UE, a sidelink communication in accordance with the configuration information.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example of sidelink communications, in accordance with the present disclosure.

FIG. 4 is a diagram illustrating an example of a sidelink resource pool configuration, in accordance with the present disclosure.

FIG. 5 is a diagram illustrating an example of sidelink communication carrier aggregation, in accordance with the present disclosure.

FIG. 6 is a diagram illustrating an example of sidelink resources for sidelink communication carrier aggregation, in accordance with the present disclosure.

FIG. 7 is a diagram illustrating an example of a resource pool configuration for sidelink carrier aggregation communications, in accordance with the present disclosure.

FIG. 8 is a diagram illustrating an example process performed, for example, at a UE or an apparatus of a UE, in accordance with the present disclosure.

FIG. 9 is a diagram illustrating an example process performed, for example, at a UE or an apparatus of a UE, in accordance with the present disclosure.

FIG. 10 is a diagram of an example apparatus for wireless communication, in accordance with the present disclosure.

### DETAILED DESCRIPTION

Communications between multiple user equipments (UEs) may be referred to as sidelink communications, and may include, for example, communications between a first UE and a second UE. A sidelink channel used for performing sidelink communications may include a physical sidelink feedback channel (PSFCH) resource, which may be used for communicating feedback, such as hybrid automatic repeat request (HARQ) feedback, between the first UE and the second UE. Sidelink communications may include Mode 1 sidelink communications, where resource selection and/or scheduling is performed by a network node, and/or Mode 2 sidelink communications, where resource selection and scheduling is performed by the first UE and/or the second UE. In some cases, carrier aggregation may be used to increase data rates and to improve performance of the sidelink communications. For example, carrier aggregation may be used to combine multiple sidelink carriers into a single logical channel, thereby allowing the first UE and the second UE to simultaneously communicate over multiple frequencies. Intra-band carrier aggregation may be used to aggregate carriers within a same frequency band into a single logical channel, whereas inter-band carrier aggregation may be used to combine carriers from different frequency bands into the single logical channel. For intra-band carrier aggregation, a mismatch between PSFCH slots in different component carriers may result in incorrect automatic gain control (AGC) settings, for example, when the aggregated component carriers are received using a common radio frequency chain. Additionally, or alternatively, the mismatch between the PSFCH slots in the different component carriers may result in transmission and reception contention caused, for example, when a UE is transmitting on one component carrier on a non-PSFCH slot and is configured to receive a PSFCH communication on another component carrier in accordance with a previously transmitted transport block. In some cases, aligning the PSFCH slots may require that the aggregated carriers be configured with a common understanding of a logical-to-physical-slot mapping with a same PSFCH periodicity, and/or may require that the aggregated carriers be configured with a mapping between logical and physical slots and PSFCH periodicity that permits alignment of the PSFCH slots. However, the first UE and/or the second UE may not be configured with this information, which may result, for example, in incorrect AGC settings and/or in transmission and reception contention.

Various aspects generally relate to wireless communications. Some aspects more specifically relate to sidelink communications and sidelink communication carrier aggregation. In some aspects, a UE may obtain configuration information associated with a sidelink communication. The configuration information may indicate that each PSFCH resource of a plurality of PSFCH resources associated with a carrier aggregation operation is to have a same time domain location (e.g., a same location in time) across all component carriers of a plurality of component carriers. Additionally, or alternatively, the configuration information may indicate that each bandwidth part of a plurality of bandwidth parts associated with the carrier aggregation operation is to be configured with a same sidelink symbol length and a same sidelink start symbol. In some aspects, a same resource pool bitmap and a same PSFCH periodicity may be configured across all component carriers of the plurality of component carriers. In some other aspects, a resource pool bitmap and PSFCH periodicity may ensure that slots that include PSFCH resources are aligned across all component carriers. The UE may communicate in accordance with the configuration information. For example, the UE may transmit a sidelink communication, or may receive a sidelink communication, in accordance with each PSFCH resource of the plurality of PSFCH resources associated with the carrier aggregation operation having the same time domain location across all component carriers of the plurality of component carriers, and in accordance with each bandwidth part of the plurality of bandwidth parts associated with the carrier aggregation operation having the same sidelink symbol length and the same sidelink start symbol.

Particular aspects of the subject matter described in this disclosure can be implemented to realize one or more of the following potential advantages. In some examples, by communicating a sidelink communication in accordance with each PSFCH resource having the same time domain location across all component carriers of the plurality of component carriers, and in accordance with each bandwidth part of a plurality of bandwidth parts having the same sidelink symbol length and the same sidelink start symbol, the described techniques can be used to improve an accuracy of AGC settings. Additionally, by communicating the sidelink communication in accordance with each PSFCH resource of the plurality of PSFCH resources having the same time domain location across all component carriers of the plurality of component carriers, and in accordance with each bandwidth part of the plurality of bandwidth parts having the same sidelink symbol length and the same sidelink start symbol, the described techniques can be used to reduce transmission and reception contention caused, for example, when the UE is transmitting on one component carrier and is configured to receive a PSFCH communication on another component carrier in accordance with a previously transmitted transport block. These example advantages, among others, are described in more detail below.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

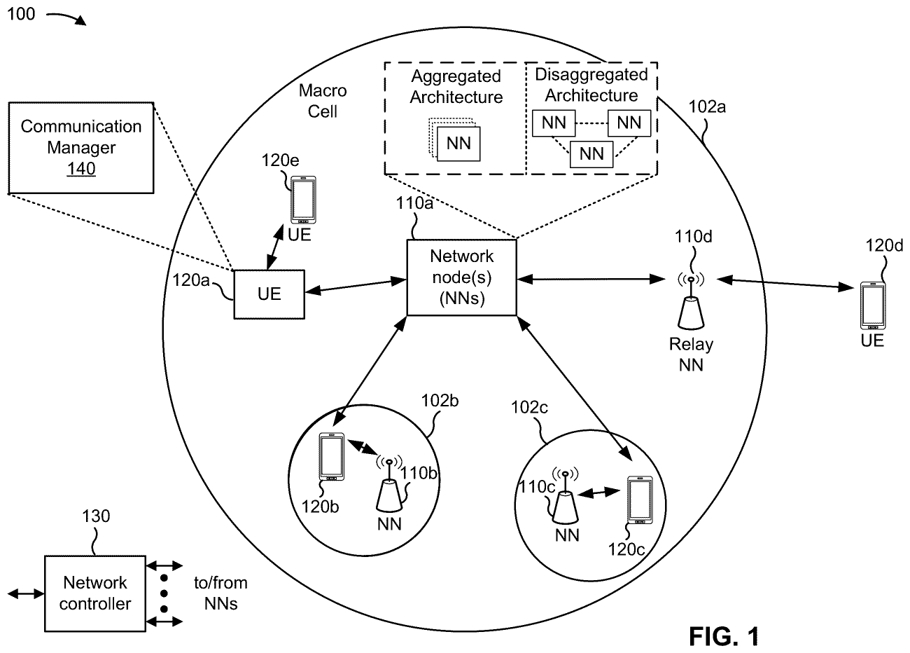

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. In some aspects, as described in more detail elsewhere herein, the communication manager 140 may obtain configuration information associated with a sidelink communication, the configuration information indicating that each PSFCH resource of a plurality of PSFCH resources associated with a carrier aggregation operation is to have a same time domain location across all component carriers of a plurality of component carriers, and indicating that each bandwidth part of a plurality of bandwidth parts associated with the carrier aggregation operation is to be configured with a same sidelink symbol length and a same sidelink start symbol; and transmit a sidelink communication in accordance with the configuration information. In some other aspects, as described in more detail elsewhere herein, the communication manager 140 may obtain configuration information associated with a sidelink communication, the configuration information indicating that each PSFCH resource of a plurality of PSFCH resources associated with a carrier aggregation operation is to have a same time domain location across all component carriers of a plurality of component carriers, and indicating that each bandwidth part of a plurality of bandwidth parts associated with the carrier aggregation operation is to be configured with a same sidelink symbol length and a same sidelink start symbol; and receive a sidelink communication in accordance with the configuration information. Additionally, or alternatively, the communication manager 140 may perform one or more other operations described herein.

As indicated above, FIG. 1 is provided as an example. Other examples may differ from what is described with regard to FIG. 1.

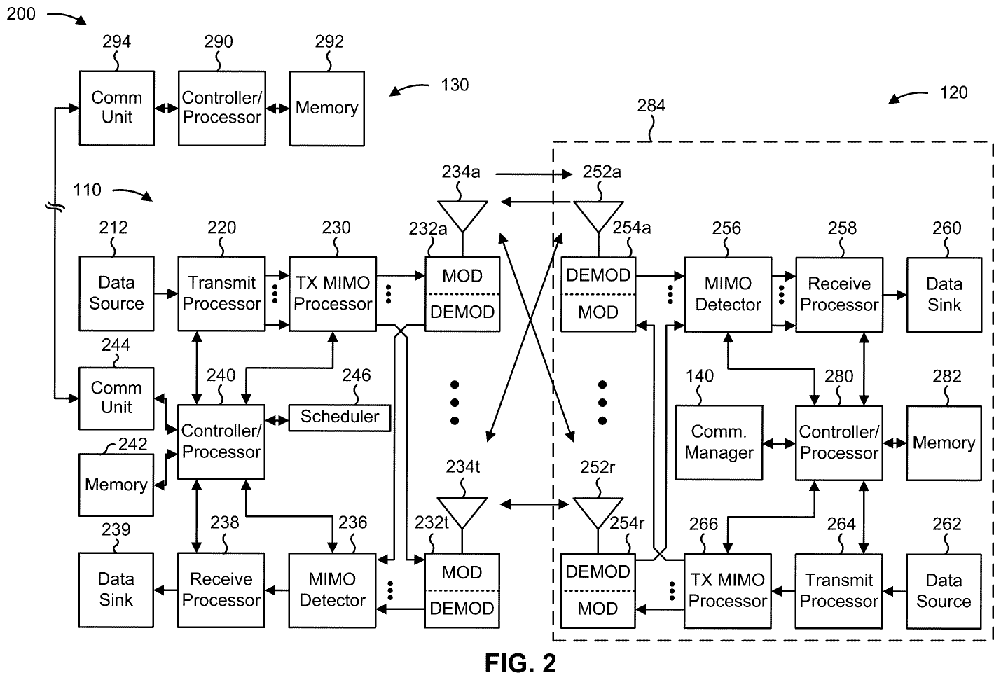

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

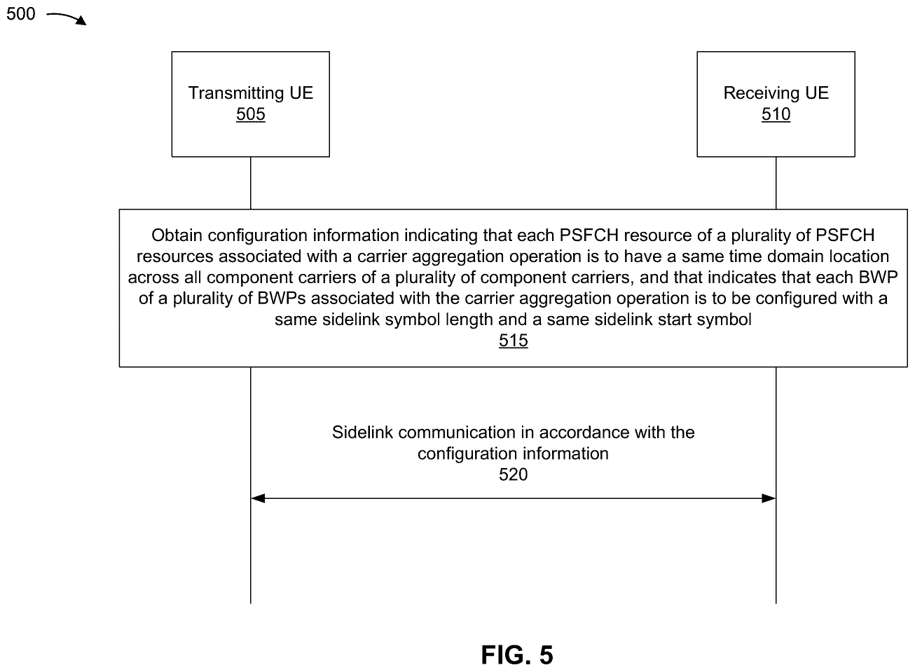

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-10).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-10).

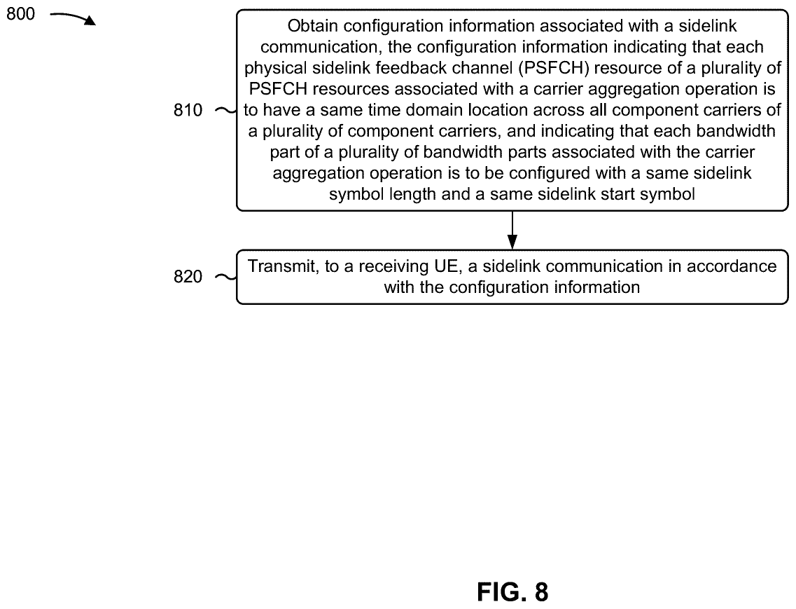

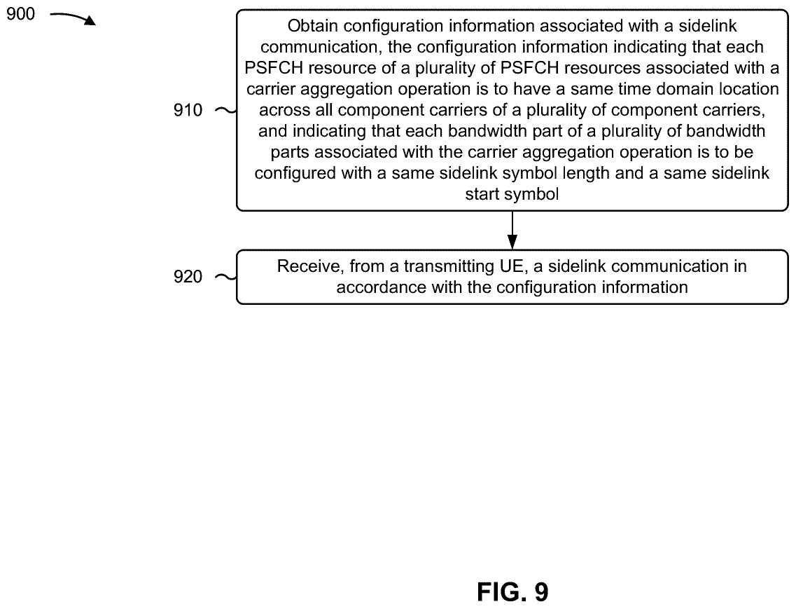

The controller/processor 240 of the network node 110, the controller/processor 280 of the UE 120, and/or any other component(s) of FIG. 2 may perform one or more techniques associated with sidelink communication carrier aggregation, as described in more detail elsewhere herein. For example, the controller/processor 240 of the network node 110, the controller/processor 280 of the UE 120, and/or any other component(s) of FIG. 2 may perform or direct operations of, for example, process 800 of FIG. 8, process 900 of FIG. 9, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, the UE 120 (e.g., a transmitting UE) includes means for obtaining configuration information associated with a sidelink communication, the configuration information indicating that each PSFCH resource of a plurality of PSFCH resources associated with a carrier aggregation operation is to have a same time domain location across all component carriers of a plurality of component carriers, and indicating that each bandwidth part of a plurality of bandwidth parts associated with the carrier aggregation operation is to be configured with a same sidelink symbol length and a same sidelink start symbol; and/or means for transmitting, to a receiving UE, a sidelink communication in accordance with the configuration information. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the UE 120 (e.g., a receiving UE) includes means for obtaining configuration information associated with a sidelink communication, the configuration information indicating that each PSFCH resource of a plurality of PSFCH resources associated with a carrier aggregation operation is to have a same time domain location across all component carriers of a plurality of component carriers, and indicating that each bandwidth part of a plurality of bandwidth parts associated with the carrier aggregation operation is to be configured with a same sidelink symbol length and a same sidelink start symbol; and/or means for receiving, from a transmitting UE, a sidelink communication in accordance with the configuration information. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

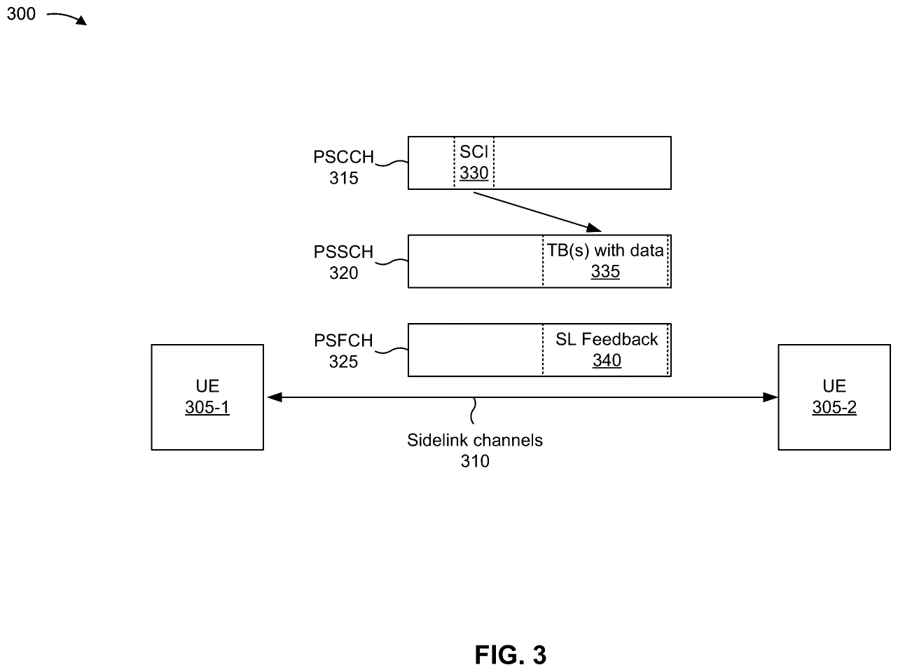

FIG. 3 is a diagram illustrating an example 300 of sidelink communications, in accordance with the present disclosure.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (e.g., which may include V2V communications, V2I communications, and/or V2P communications) and/or mesh networking. In some aspects, the UEs 305 (e.g., UE 305-1 and/or UE 305-2) may correspond to one or more other UEs described elsewhere herein, such as UE 120. In some aspects, the one or more sidelink channels 310 may use a PC5 interface and/or may operate in a high frequency band (e.g., the 5.9 GHz band). Additionally, or alternatively, the UEs 305 may synchronize timing of transmission time intervals (TTIs) (e.g., frames, subframes, slots, or symbols) using global navigation satellite system (GNSS) timing.

As further shown in FIG. 3, the one or more sidelink channels 310 may include a physical sidelink control channel (PSCCH) 315, a physical sidelink shared channel (PSSCH) 320, and/or a physical sidelink feedback channel (PSFCH) 325. The PSCCH 315 may be used to communicate control information, similar to a physical downlink control channel (PDCCH) and/or a physical uplink control channel (PUCCH) used for cellular communications with a network node 110 via an access link or an access channel. The PSSCH 320 may be used to communicate data, similar to a physical downlink shared channel (PDSCH) and/or a physical uplink shared channel (PUSCH) used for cellular communications with a network node 110 via an access link or an access channel. For example, the PSCCH 315 may carry sidelink control information (SCI) 330, which may indicate various control information used for sidelink communications, such as one or more resources (e.g., time resources, frequency resources, and/or spatial resources) where a transport block (TB) 335 may be carried on the PSSCH 320. The TB 335 may include data. The PSFCH 325 may be used to communicate sidelink feedback 340, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 315, in some aspects, the SCI 330 may include multiple communications in different stages, such as a first stage SCI (SCI-1) and a second stage SCI (SCI-2). The SCI-1 may be transmitted on the PSCCH 315. The SCI-2 may be transmitted on the PSSCH 320. The SCI-1 may include, for example, an indication of one or more resources (e.g., time resources, frequency resources, and/or spatial resources) on the PSSCH 320, information for decoding sidelink communications on the PSSCH, a quality of service (QoS) priority value, a resource reservation period, a PSSCH demodulation reference signal (DMRS) pattern, an SCI format for the SCI-2, a beta offset for the SCI-2, a quantity of PSSCH DMRS ports, and/or a modulation and coding scheme (MCS). The SCI-2 may include information associated with data transmissions on the PSSCH 320, such as a hybrid automatic repeat request (HARQ) process ID, a new data indicator (NDI), a source identifier, a destination identifier, and/or a channel state information (CSI) report trigger.

In some aspects, the one or more sidelink channels 310 may use resource pools. For example, a scheduling assignment (e.g., included in SCI 330) may be transmitted in sub-channels using specific resource blocks (RBs) across time. In some aspects, data transmissions (e.g., on the PSSCH 320) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 305 may operate using a sidelink transmission mode (e.g., Mode 1) where resource selection and/or scheduling is performed by a network node 110 (e.g., a base station, a CU, or a DU). For example, the UE 305 may receive a grant (e.g., in downlink control information (DCI) or in a radio resource control (RRC) message, such as for configured grants) from the network node 110 (e.g., directly or via one or more network nodes) for sidelink channel access and/or scheduling. In some aspects, a UE 305 may operate using a transmission mode (e.g., Mode 2) where resource selection and/or scheduling is performed by the UE 305 (e.g., rather than a network node 110). In some aspects, the UE 305 may perform resource selection and/or scheduling by sensing channel availability for transmissions. For example, the UE 305 may measure a received signal strength indicator (RSSI) parameter (e.g., a sidelink-RSSI (S-RSSI) parameter) associated with various sidelink channels, may measure a reference signal received power (RSRP) parameter (e.g., a PSSCH-RSRP parameter) associated with various sidelink channels, and/or may measure a reference signal received quality (RSRQ) parameter (e.g., a PSSCH-RSRQ parameter) associated with various sidelink channels, and may select a channel for transmission of a sidelink communication based at least in part on the measurement(s).

Additionally, or alternatively, the UE 305 may perform resource selection and/or scheduling using SCI 330 received in the PSCCH 315, which may indicate occupied resources and/or channel parameters. Additionally, or alternatively, the UE 305 may perform resource selection and/or scheduling by determining a channel busy ratio (CBR) associated with various sidelink channels, which may be used for rate control (e.g., by indicating a maximum number of resource blocks that the UE 305 can use for a particular set of subframes).

In the transmission mode where resource selection and/or scheduling is performed by a UE 305, the UE 305 may generate sidelink grants, and may transmit the grants in SCI 330. A sidelink grant may indicate, for example, one or more parameters (e.g., transmission parameters) to be used for an upcoming sidelink transmission, such as one or more resource blocks to be used for the upcoming sidelink transmission on the PSSCH 320 (e.g., for TBs 335), one or more subframes to be used for the upcoming sidelink transmission, and/or a modulation and coding scheme (MCS) to be used for the upcoming sidelink transmission. In some aspects, a UE 305 may generate a sidelink grant that indicates one or more parameters for semi-persistent scheduling (SPS), such as a periodicity of a sidelink transmission. Additionally, or alternatively, the UE 305 may generate a sidelink grant for event-driven scheduling, such as for an on-demand sidelink message.

As indicated above, FIG. 3 is provided as an example. Other examples may differ from what is described with respect to FIG. 3.

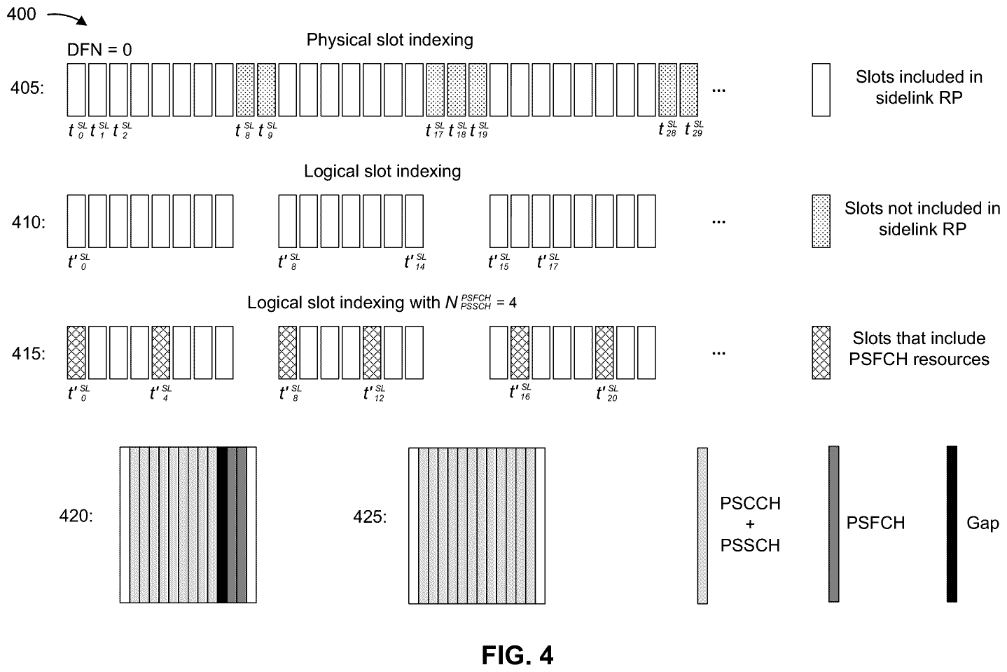

FIG. 4 is a diagram illustrating an example 400 of a sidelink resource pool configuration, in accordance with the present disclosure.

A sidelink Mode 2 resource pool (RP) may be configured with a set of slots. The set of slots may be indicated by:
(t₀^{SL}, t₁^{SL}, . . . , t_{T}_{ₘₐₓ}₋₁^{SL}), where
0≤tᵢ^{SL}<10240×2^{μ}, and
0≤i≤Tₘₐₓ.

An example of physical slots for sidelink communications is shown in example 405. For Mode 2 sidelink communications, an index may be defined in accordance with an initial slot number (e.g., slot 0) of a radio frame corresponding to an initial direct frame number (DFN) (e.g., DFN 0). Slots that are included in a resource pool may be used for sidelink communications. Slots that are not included in the resource pool may be used for NR sidelink synchronization, uplink transmissions (e.g., in coverage scenarios), or as other reserved slots (e.g., for LTE sidelink).

In some cases, a UE may determine a set of slots assigned for sidelink communications in the resource pool using a bitmap. A bitmap of length L may correspond to a physical slot. As shown in example 410, the UE may index the physical slots that are available in the resource pool as tᵢ′^{SL}, where i=0, 1, . . . , Tₘₐₓ′−1, and Tₘₐₓ′ is a number of physical slots in the sidelink resource pool. Indexing the physical slots may include mapping the set of physical slots to a set of logical slots, and numbering (e.g., renumbering) the logical slots (as shown in example 410).

In some cases, a sidelink resource pool may include one or more PSFCH resources. Resources for NR sidelink feedback may be configured periodically, where the periodicity is configured by a parameter N_{PSSCH}^{PSFCH}={1, 2, 4}. In one example, as shown by reference number 415, the logical slot indices and PSFCH resources may be defined with N_{PSSCH}^{PSFCH}=4. In some cases, a mapping of the PSFCH slots may be in accordance with one or more logical slot indices tᵢ′^{SL}. In some cases, as shown by reference number 420, a slot may include one or more PSFCH resources, and in some other cases, as shown by reference number 425, the slot may not include any PSFCH resources. In one example slot that includes PSFCH resources, symbols 11 and 12 may be allocated for PSFCH communications, and symbol 10 may be used as a gap symbol that enables the UE to switch between transmitting and receiving.

As indicated above, FIG. 4 is provided as an example. Other examples may differ from what is described with respect to FIG. 4.

FIG. 5 is a diagram illustrating an example 500 of sidelink communication carrier aggregation, in accordance with the present disclosure. A transmitting UE 505 may communicate with a receiving UE 510. The transmitting UE 505 may include some or all of the features of the UE 120 and/or the UE 305. Additionally, or alternatively, the receiving UE 510 may include some or all of the features of the UE 120 and/or the UE 305.

As shown by reference number 515, the transmitting UE 505 and/or the receiving UE 510 may obtain configuration information associated with sidelink communications. The configuration information may indicate that each PSFCH resource of a plurality of PSFCH resources associated with a carrier aggregation operation is to have a same time domain location across all component carriers of a plurality of component carriers. Additionally, or alternatively, the configuration information may indicate that each bandwidth part (BWP) of a plurality of BWPs associated with the carrier aggregation operation is to be configured with a same sidelink symbol length and a same sidelink start symbol. The carrier aggregation operation may be an intra-band carrier aggregation operation. In some aspects, the configuration information may indicate that a DFN and a DFN offset are to be the same across all component carriers of the plurality of component carriers. Additionally, or alternatively, the configuration information may indicate that each BWP associated with the carrier aggregation operation is to have a same OFDM numerology.

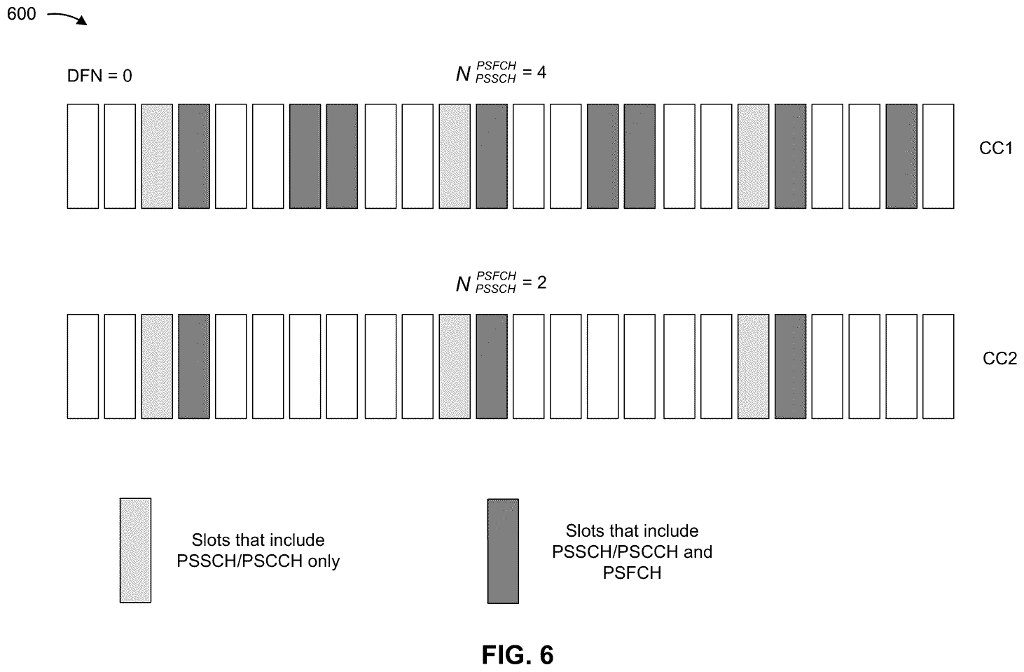

In some aspects, the transmitting UE 505 and/or the receiving UE 510 may be configured with a same resource pool bitmap and a same PSFCH periodicity across all component carriers of the plurality of component carriers associated with the carrier aggregation operation. Thus, each PSFCH resource of the plurality of PSFCH resources may be aligned across all component carriers of the plurality of component carriers. In some other aspects, the transmitting UE 505 and/or the receiving UE 510 may be configured with a resource pool bitmap and a PSFCH periodicity that ensures that slots that include PSFCH resources are aligned across all component carriers of the plurality of component carriers. Additional details regarding these features are described in connection with FIG. 6.

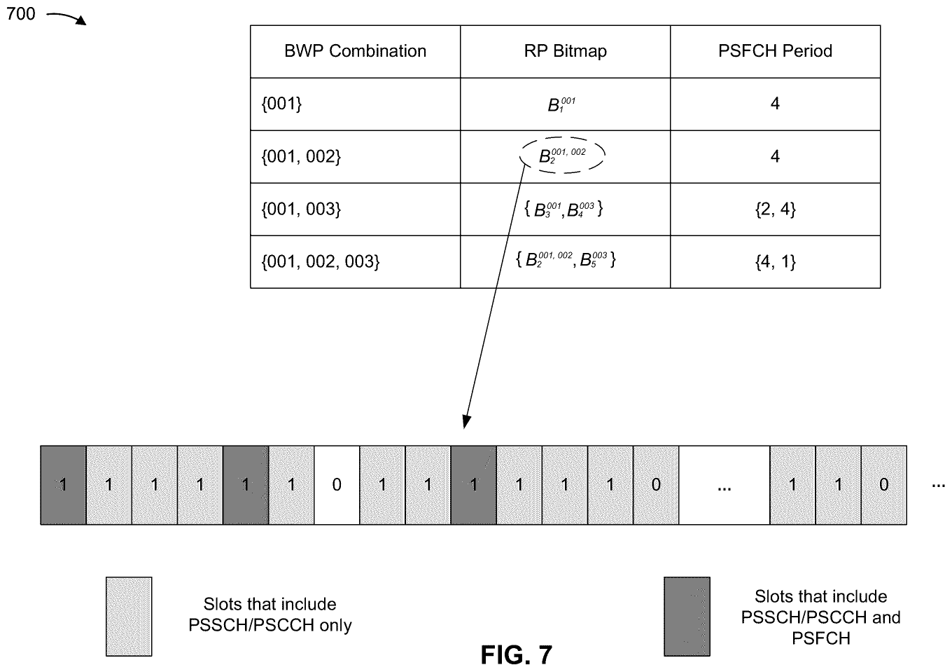

In some aspects, a resource pool configuration for the sidelink communication may be configured per-BWP of the plurality of BWPs. In one example, for at least one BWP of the plurality of BWPs, a first transmission resource pool may be configured for carrier aggregation operation communications and a second transmission resource pool (that is separate from the first transmission resource pool) may be configured for non-carrier-aggregation-operation communications. In some aspects, a transmission resource for the carrier aggregation operation may be configured for each possible BWP combination of a plurality of possible BWP combinations. Each BWP combination of the plurality of BWP combinations may be associated with (e.g., defined by) a set of BWP identifiers (BWP ID). Each BWP ID of the plurality of BWP IDs may be associated with one or more sidelink resource pool bitmaps (Bᵢ^{BWP_id}) and a PSFCH periodicity (1, 2, or 4) associated with the one or more bitmaps. Additional details regarding these features are described in connection with FIG. 7.

In some aspects, the transmitting UE 505 may be configured (e.g., pre-configured) with the configuration information, and may obtain the configuration information from a memory of the transmitting UE 505. Additionally, or alternatively, the transmitting UE 505 may receive an indication of the configuration information from a network node. In some aspects, the receiving UE 510 may be configured (e.g., pre-configured) with the configuration information, and may obtain the configuration information from a memory of the receiving UE 510. Additionally, or alternatively, the receiving UE 510 may receive an indication of the configuration information from a network node.

As shown by reference number 520, the transmitting UE 505 may transmit, and the receiving UE 510 may receive, a sidelink communication in accordance with the configuration information. For example, the transmitting UE 505 may transmit, and the receiving UE 510 may receive, the sidelink communication in accordance with each PSFCH resource of the plurality of PSFCH resources associated with the carrier aggregation operation having the same time domain location across all component carriers of the plurality of component carriers, and in accordance with each bandwidth part of the plurality of bandwidth parts associated with the carrier aggregation operation having the same sidelink symbol length and the same sidelink start symbol.

As indicated above, FIG. 5 is provided as an example. Other examples may differ from what is described with respect to FIG. 5.

FIG. 6 is a diagram illustrating an example 600 of sidelink resources for sidelink communication carrier aggregation, in accordance with the present disclosure. In some aspects, for example, as described in connection with FIG. 5, a transmitting UE and a receiving UE may be configured with a same resource pool bitmap and a same PSFCH periodicity across all component carriers of a plurality of component carriers associated with a carrier aggregation operation. Thus, each PSFCH resource of a plurality of PSFCH resources associated with the component carrier operation may be aligned across all component carriers of the plurality of component carriers. In some other aspects, the transmitting UE and the receiving UE may be configured with a resource pool bitmap and a PSFCH periodicity indication that ensures that slots that include PSFCH resources are aligned across all component carriers of the plurality of component carriers. For example, as shown in example 600, a first component carrier (CC1) may be configured with a first plurality of slots that include PSSCH/PSCCH resources and PSFCH resources, and a first plurality of slots that include only PSSCH/PSCCH resources (e.g., slots that do not include PSFCH resources), in accordance with a first parameter N_{PSSCH}^{PSFCH}=4. Additionally, a second component carrier (CC2) may be configured with a second plurality of slots that include PSSCH/PSCCH resources and PSFCH resources, and a second plurality of slots that include only PSSCH/PSCCH resources (e.g., slots that do not include PSFCH resources), in accordance with a second parameter N_{PSSCH}^{PSFCH}=2. The slots that include the PSFCH resources (e.g., the first plurality of slots that include the PSSCH/PSCCH resources and the PSFCH resources, and the second plurality of slots that include the PSSCH/PSCCH resources and the PSFCH resources) may be aligned across all component carriers (such as CC1 and CC2, among other examples).

As indicated above, FIG. 6 is provided as an example. Other examples may differ from what is described with respect to FIG. 6.

FIG. 7 is a diagram illustrating an example 700 of a resource pool configuration for sidelink carrier aggregation communications, in accordance with the present disclosure. In some aspects, for example, as described in connection with FIG. 5, a resource pool configuration for a sidelink communication may be configured per-BWP of a plurality of BWPs. In one example, for at least one BWP of the plurality of BWPs, a first transmission resource pool may be configured for carrier aggregation operation communications and a second transmission resource pool (that is separate from the first transmission resource pool) may be configured for non-carrier-aggregation-operation communications. In some aspects, a transmission resource for a carrier aggregation operation may be configured for each possible BWP combination of a plurality of possible BWP combinations. Each BWP combination of the plurality of BWP combinations may be associated with (e.g., defined by) a set of BWP identifiers (BWP IDs). Each BWP ID of the plurality of BWP IDs may be associated with one or more sidelink resource pool bitmaps (Bᵢ^{BWP_id}) and a PSFCH periodicity (1, 2, or 4) associated with the one or more bitmaps. In one example, in the case of BWP combination {001, 002}, a common bitmap (B₂^{001,002}) may be used with a PSFCH periodicity of 4. In another example, for a combination of BWPs {001, 003}, two separate resource pool bitmaps (B₃⁰⁰¹, B₄⁰⁰³) may be used with different PSFCH periodicities (2 and 4, respectively) for each of the component carriers. The selection of the bitmaps may align with the PSFCH slots. In some aspects, a first entry {001} may correspond to a transmission resource pool bitmap that is used when only a first BWP (BWP-001) is used (e.g., there is no carrier aggregation).

As indicated above, FIG. 7 is provided as an example. Other examples may differ from what is described with respect to FIG. 7.

FIG. 8 is a diagram illustrating an example process 800 performed, for example, at a UE or an apparatus of a UE, in accordance with the present disclosure. Example process 800 is an example where the apparatus or the UE (e.g., UE 120) performs operations associated with sidelink communication carrier aggregation.

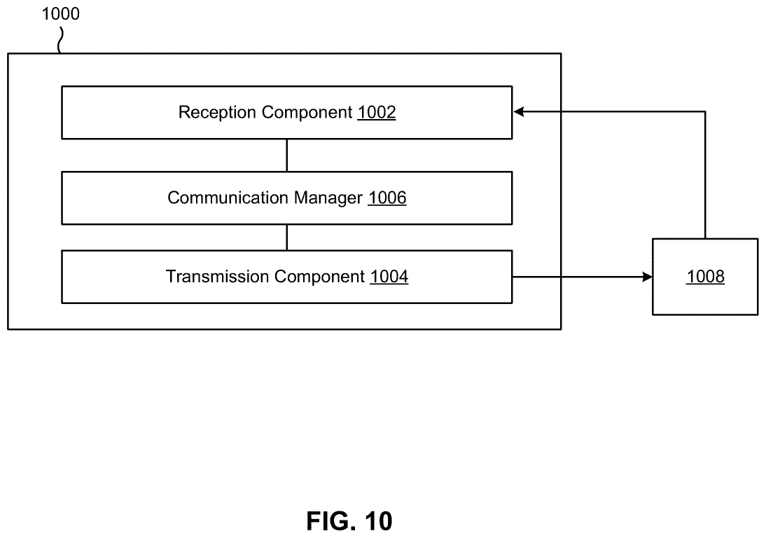

As shown in FIG. 8, in some aspects, process 800 may include obtaining configuration information associated with a sidelink communication, the configuration information indicating that each PSFCH resource of a plurality of PSFCH resources associated with a carrier aggregation operation is to have a same time domain location across all component carriers of a plurality of component carriers, and indicating that each bandwidth part of a plurality of bandwidth parts associated with the carrier aggregation operation is to be configured with a same sidelink symbol length and a same sidelink start symbol (block 810). For example, the UE (e.g., using reception component 1002 and/or communication manager 1006, depicted in FIG. 10) may obtain configuration information associated with a sidelink communication, the configuration information indicating that each PSFCH resource of a plurality of PSFCH resources associated with a carrier aggregation operation is to have a same time domain location across all component carriers of a plurality of component carriers, and indicating that each bandwidth part of a plurality of bandwidth parts associated with the carrier aggregation operation is to be configured with a same sidelink symbol length and a same sidelink start symbol, as described above.

As further shown in FIG. 8, in some aspects, process 800 may include transmitting, to a receiving UE, a sidelink communication in accordance with the configuration information (block 820). For example, the UE (e.g., using transmission component 1004 and/or communication manager 1006, depicted in FIG. 10) may transmit, to a receiving UE, a sidelink communication in accordance with the configuration information, as described above.

Process 800 may include additional aspects, such as any single aspect or any combination of aspects described below and/or in connection with one or more other processes described elsewhere herein.

In a first aspect, transmitting the sidelink communication in accordance with the configuration information comprises transmitting, to the receiving UE, the sidelink communication in accordance with each PSFCH resource of the plurality of PSFCH resources associated with the carrier aggregation operation having the same time domain location across all component carriers of the plurality of component carriers, and in accordance with each bandwidth part of the plurality of bandwidth parts associated with the carrier aggregation operation having the same sidelink symbol length and the same sidelink start symbol.

In a second aspect, alone or in combination with the first aspect, each component carrier of the plurality of component carriers is associated with a same direct frame number and a same direct frame number offset.

In a third aspect, alone or in combination with one or more of the first and second aspects, each bandwidth part of the plurality of bandwidth parts is associated with a same orthogonal frequency-division multiplexing numerology.

In a fourth aspect, alone or in combination with one or more of the first through third aspects, each component carrier of the plurality of component carriers is configured with a same resource pool bitmap and a same PSFCH periodicity.

In a fifth aspect, alone or in combination with one or more of the first through fourth aspects, at least two component carriers of the plurality of component carriers are configured with different resource pool bitmaps and different PSFCH periodicities, and each PSFCH resource of the plurality of PSFCH resources associated with the carrier aggregation operation has the same time domain location across all component carriers of the plurality of component carriers in accordance with a resource pool bitmap and a PSFCH periodicity indicating that each PSFCH resource of the plurality of PSFCH resources is to have the same time domain location across all component carriers of the plurality of component carriers.

In a sixth aspect, alone or in combination with one or more of the first through fifth aspects, a resource pool configuration to be used for transmitting the sidelink communication is configured per bandwidth part of the plurality of bandwidth parts.

In a seventh aspect, alone or in combination with one or more of the first through sixth aspects, the resource pool configuration includes a first transmission resource pool configured for carrier aggregation operation communications and a second transmission resource pool configured for non-carrier-aggregation-operation communications.

In an eighth aspect, alone or in combination with one or more of the first through seventh aspects, a transmission resource pool configured for carrier aggregation operation communications is configured for each bandwidth part combination of a plurality of bandwidth part combinations associated with the plurality of bandwidth parts.

In a ninth aspect, alone or in combination with one or more of the first through eighth aspects, each bandwidth part combination of the plurality of bandwidth part combinations is associated with one or more bandwidth part identifiers, wherein each bandwidth part identifier of a plurality of bandwidth part identifiers is associated with one or more sidelink resource pool bitmap identifiers and a PSFCH periodicity indicator.

In a tenth aspect, alone or in combination with one or more of the first through ninth aspects, process 800 includes obtaining an indication of the resource pool configuration from a memory of the transmitting UE.

In an eleventh aspect, alone or in combination with one or more of the first through tenth aspects, process 800 includes receiving, from a network node, an indication of the resource pool configuration.

In a twelfth aspect, alone or in combination with one or more of the first through eleventh aspects, the carrier aggregation operation is an intra-band carrier aggregation operation.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, at a UE or an apparatus of a UE, in accordance with the present disclosure. Example process 900 is an example where the apparatus or the UE (e.g., UE 120) performs operations associated with sidelink communication carrier aggregation.

As shown in FIG. 9, in some aspects, process 900 may include obtaining configuration information associated with a sidelink communication, the configuration information indicating that each PSFCH resource of a plurality of PSFCH resources associated with a carrier aggregation operation is to have a same time domain location across all component carriers of a plurality of component carriers, and indicating that each bandwidth part of a plurality of bandwidth parts associated with the carrier aggregation operation is to be configured with a same sidelink symbol length and a same sidelink start symbol (block 910). For example, the UE (e.g., using reception component 1002 and/or communication manager 1006, depicted in FIG. 10) may obtain configuration information associated with a sidelink communication, the configuration information indicating that each PSFCH resource of a plurality of PSFCH resources associated with a carrier aggregation operation is to have a same time domain location across all component carriers of a plurality of component carriers, and indicating that each bandwidth part of a plurality of bandwidth parts associated with the carrier aggregation operation is to be configured with a same sidelink symbol length and a same sidelink start symbol, as described above.

As further shown in FIG. 9, in some aspects, process 900 may include receiving, from a transmitting UE, a sidelink communication in accordance with the configuration information (block 920). For example, the UE (e.g., using reception component 1002 and/or communication manager 1006, depicted in FIG. 10) may receive, from a transmitting UE, a sidelink communication in accordance with the configuration information, as described above.

Process 900 may include additional aspects, such as any single aspect or any combination of aspects described below and/or in connection with one or more other processes described elsewhere herein.

In a first aspect, receiving the sidelink communication in accordance with the configuration information comprises receiving, from the transmitting UE, the sidelink communication in accordance with each PSFCH resource of the plurality of PSFCH resources associated with the carrier aggregation operation having the same time domain location across all component carriers of the plurality of component carriers, and in accordance with each bandwidth part of the plurality of bandwidth parts associated with the carrier aggregation operation having the same sidelink symbol length and the same sidelink start symbol.

In a second aspect, alone or in combination with the first aspect, each component carrier of the plurality of component carriers is associated with a same direct frame number and a same direct frame number offset.

In a third aspect, alone or in combination with one or more of the first and second aspects, each bandwidth part of the plurality of bandwidth parts is associated with a same orthogonal frequency-division multiplexing numerology.

In a fourth aspect, alone or in combination with one or more of the first through third aspects, each component carrier of the plurality of component carriers is configured with a same resource pool bitmap and a same PSFCH periodicity.

In a fifth aspect, alone or in combination with one or more of the first through fourth aspects, at least two component carriers of the plurality of component carriers are configured with different resource pool bitmaps and different PSFCH periodicities, and each PSFCH resource of the plurality of PSFCH resources associated with the carrier aggregation operation has the same time domain location across all component carriers of the plurality of component carriers in accordance with a resource pool bitmap and a PSFCH periodicity indicating that each PSFCH resource of the plurality of PSFCH resources is to have the same time domain location across all component carriers of the plurality of component carriers.

In a sixth aspect, alone or in combination with one or more of the first through fifth aspects, a resource pool configuration to be used for receiving the sidelink communication is configured per bandwidth part of the plurality of bandwidth parts.

In a seventh aspect, alone or in combination with one or more of the first through sixth aspects, the resource pool configuration includes a first transmission resource pool configured for carrier aggregation operation communications and a second transmission resource pool configured for non-carrier-aggregation-operation communications.

In an eighth aspect, alone or in combination with one or more of the first through seventh aspects, a transmission resource pool configured for carrier aggregation operation communications is configured for each bandwidth part combination of a plurality of bandwidth part combinations associated with the plurality of bandwidth parts.

In a ninth aspect, alone or in combination with one or more of the first through eighth aspects, each bandwidth part combination of the plurality of bandwidth part combinations is associated with one or more bandwidth part identifiers, wherein each bandwidth part identifier of a plurality of bandwidth part identifiers is associated with one or more sidelink resource pool bitmap identifiers and a PSFCH periodicity indicator.

In a tenth aspect, alone or in combination with one or more of the first through ninth aspects, process 900 includes obtaining an indication of the resource pool configuration from a memory of the receiving UE.

In an eleventh aspect, alone or in combination with one or more of the first through tenth aspects, process 900 includes receiving, from a network node, an indication of the resource pool configuration.

In a twelfth aspect, alone or in combination with one or more of the first through eleventh aspects, the carrier aggregation operation is an intra-band carrier aggregation operation.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 140 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIGS. 5-7. Additionally, or alternatively, the apparatus 1000 may be configured to perform one or more processes described herein, such as process 800 of FIG. 8, process 900 of FIG. 9, or a combination thereof. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 1004 may be co-located with the reception component 1002 in one or more transceivers.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The reception component 1002 may obtain configuration information associated with a sidelink communication, the configuration information indicating that each PSFCH resource of a plurality of PSFCH resources associated with a carrier aggregation operation is to have a same time domain location across all component carriers of a plurality of component carriers, and indicating that each bandwidth part of a plurality of bandwidth parts associated with the carrier aggregation operation is to be configured with a same sidelink symbol length and a same sidelink start symbol. The transmission component 1004 may transmit, to a receiving UE, a sidelink communication in accordance with the configuration information. The reception component 1002 may obtain an indication of the resource pool configuration from a memory of the transmitting UE. The reception component 1002 may receive, from a network node, an indication of the resource pool configuration.

The reception component 1002 may obtain configuration information associated with a sidelink communication, the configuration information indicating that each PSFCH resource of a plurality of PSFCH resources associated with a carrier aggregation operation is to have a same time domain location across all component carriers of a plurality of component carriers, and indicating that each bandwidth part of a plurality of bandwidth parts associated with the carrier aggregation operation is to be configured with a same sidelink symbol length and a same sidelink start symbol. The reception component 1002 may receive, from a transmitting UE, a sidelink communication in accordance with the configuration information. The reception component 1002 may obtain an indication of the resource pool configuration from a memory of the receiving UE. The reception component 1002 may receive, from a network node, an indication of the resource pool configuration.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a transmitting user equipment (UE), comprising: obtaining configuration information associated with a sidelink communication, the configuration information indicating that each physical sidelink feedback channel (PSFCH) resource of a plurality of PSFCH resources associated with a carrier aggregation operation is to have a same time domain location across all component carriers of a plurality of component carriers, and indicating that each bandwidth part of a plurality of bandwidth parts associated with the carrier aggregation operation is to be configured with a same sidelink symbol length and a same sidelink start symbol; and transmitting, to a receiving UE, a sidelink communication in accordance with the configuration information.

Aspect 2: The method of Aspect 1, wherein transmitting the sidelink communication in accordance with the configuration information comprises transmitting, to the receiving UE, the sidelink communication in accordance with each PSFCH resource of the plurality of PSFCH resources associated with the carrier aggregation operation having the same time domain location across all component carriers of the plurality of component carriers, and in accordance with each bandwidth part of the plurality of bandwidth parts associated with the carrier aggregation operation having the same sidelink symbol length and the same sidelink start symbol.

Aspect 3: The method of any of Aspects 1-2, wherein each component carrier of the plurality of component carriers is associated with a same direct frame number and a same direct frame number offset.

Aspect 4: The method of any of Aspects 1-3, wherein each bandwidth part of the plurality of bandwidth parts is associated with a same orthogonal frequency-division multiplexing numerology.

Aspect 5: The method of any of Aspects 1-4, wherein each component carrier of the plurality of component carriers is configured with a same resource pool bitmap and a same PSFCH periodicity.

Aspect 6: The method of any of Aspects 1-5, wherein at least two component carriers of the plurality of component carriers are configured with different resource pool bitmaps and different PSFCH periodicities, and wherein each PSFCH resource of the plurality of PSFCH resources associated with the carrier aggregation operation has the same time domain location across all component carriers of the plurality of component carriers in accordance with a resource pool bitmap and a PSFCH periodicity indicating that each PSFCH resource of the plurality of PSFCH resources is to have the same time domain location across all component carriers of the plurality of component carriers.

Aspect 7: The method of any of Aspects 1-6, wherein a resource pool configuration to be used for transmitting the sidelink communication is configured per bandwidth part of the plurality of bandwidth parts.

Aspect 8: The method of Aspect 7, wherein the resource pool configuration includes a first transmission resource pool configured for carrier aggregation operation communications and a second transmission resource pool configured for non-carrier-aggregation-operation communications.

Aspect 9: The method of Aspect 7, wherein a transmission resource pool configured for carrier aggregation operation communications is configured for each bandwidth part combination of a plurality of bandwidth part combinations associated with the plurality of bandwidth parts.

Aspect 10: The method of Aspect 9, wherein each bandwidth part combination of the plurality of bandwidth part combinations is associated with one or more bandwidth part identifiers, wherein each bandwidth part identifier of a plurality of bandwidth part identifiers is associated with one or more sidelink resource pool bitmap identifiers and a PSFCH periodicity indicator.

Aspect 11: The method of Aspect 7, further comprising obtaining an indication of the resource pool configuration from a memory of the transmitting UE.

Aspect 12: The method of Aspect 7, further comprising receiving, from a network node, an indication of the resource pool configuration.

Aspect 13: The method of any of Aspects 1-12, wherein the carrier aggregation operation is an intra-band carrier aggregation operation.

Aspect 14: A method of wireless communication performed by a receiving user equipment (UE), comprising: obtaining configuration information associated with a sidelink communication, the configuration information indicating that each physical sidelink feedback channel (PSFCH) resource of a plurality of PSFCH resources associated with a carrier aggregation operation is to have a same time domain location across all component carriers of a plurality of component carriers, and indicating that each bandwidth part of a plurality of bandwidth parts associated with the carrier aggregation operation is to be configured with a same sidelink symbol length and a same sidelink start symbol; and receiving, from a transmitting UE, a sidelink communication in accordance with the configuration information.

Aspect 15: The method of Aspect 14, wherein receiving the sidelink communication in accordance with the configuration information comprises receiving, from the transmitting UE, the sidelink communication in accordance with each PSFCH resource of the plurality of PSFCH resources associated with the carrier aggregation operation having the same time domain location across all component carriers of the plurality of component carriers, and in accordance with each bandwidth part of the plurality of bandwidth parts associated with the carrier aggregation operation having the same sidelink symbol length and the same sidelink start symbol.

Aspect 16: The method of any of Aspects 14-15, wherein each component carrier of the plurality of component carriers is associated with a same direct frame number and a same direct frame number offset.

Aspect 17: The method of any of Aspects 14-16, wherein each bandwidth part of the plurality of bandwidth parts is associated with a same orthogonal frequency-division multiplexing numerology.

Aspect 18: The method of any of Aspects 14-17, wherein each component carrier of the plurality of component carriers is configured with a same resource pool bitmap and a same PSFCH periodicity.

Aspect 19: The method of any of Aspects 14-18, wherein at least two component carriers of the plurality of component carriers are configured with different resource pool bitmaps and different PSFCH periodicities, and wherein each PSFCH resource of the plurality of PSFCH resources associated with the carrier aggregation operation has the same time domain location across all component carriers of the plurality of component carriers in accordance with a resource pool bitmap and a PSFCH periodicity indicating that each PSFCH resource of the plurality of PSFCH resources is to have the same time domain location across all component carriers of the plurality of component carriers.

Aspect 20: The method of any of Aspects 14-19, wherein a resource pool configuration to be used for receiving the sidelink communication is configured per bandwidth part of the plurality of bandwidth parts.

Aspect 21: The method of Aspect 20, wherein the resource pool configuration includes a first transmission resource pool configured for carrier aggregation operation communications and a second transmission resource pool configured for non-carrier-aggregation-operation communications.

Aspect 22: The method of Aspect 20, wherein a transmission resource pool configured for carrier aggregation operation communications is configured for each bandwidth part combination of a plurality of bandwidth part combinations associated with the plurality of bandwidth parts.

Aspect 23: The method of Aspect 22, wherein each bandwidth part combination of the plurality of bandwidth part combinations is associated with one or more bandwidth part identifiers, wherein each bandwidth part identifier of a plurality of bandwidth part identifiers is associated with one or more sidelink resource pool bitmap identifiers and a PSFCH periodicity indicator.

Aspect 24: The method of Aspect 20, further comprising obtaining an indication of the resource pool configuration from a memory of the receiving UE.

Aspect 25: The method of Aspect 20, further comprising receiving, from a network node, an indication of the resource pool configuration.

Aspect 26: The method of any of Aspects 14-25, wherein the carrier aggregation operation is an intra-band carrier aggregation operation.

Aspect 27: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-26.

Aspect 28: An apparatus for wireless communication at a device, the apparatus comprising one or more memories and one or more processors coupled to the one or more memories, the one or more processors configured to cause the device to perform the method of one or more of Aspects 1-26.

Aspect 29: An apparatus for wireless communication, the apparatus comprising at least one means for performing the method of one or more of Aspects 1-26.

Aspect 30: A non-transitory computer-readable medium storing code for wireless communication, the code comprising instructions executable by one or more processors to perform the method of one or more of Aspects 1-26.

Aspect 31: A non-transitory computer-readable medium storing a set of instructions for wireless communication, the set of instructions comprising one or more instructions that, when executed by one or more processors of a device, cause the device to perform the method of one or more of Aspects 1-26.

Aspect 32: A device for wireless communication, the device comprising a processing system that includes one or more processors and one or more memories coupled with the one or more processors, the processing system configured to cause the device to perform the method of one or more of Aspects 1-26.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A transmitting user equipment (UE) for wireless communication, comprising:
one or more memories; and
one or more processors, coupled to the one or more memories, configured to:
obtain configuration information associated with a sidelink communication, the configuration information indicating that each physical sidelink feedback channel (PSFCH) resource of a plurality of PSFCH resources associated with a carrier aggregation operation is to have a same time domain location across all component carriers of a plurality of component carriers, and indicating that each bandwidth part of a plurality of bandwidth parts associated with the carrier aggregation operation is to be configured with a same sidelink symbol length and a same sidelink start symbol; and
transmit, to a receiving UE, a sidelink communication in accordance with the configuration information.

2. The transmitting UE of claim 1, wherein the one or more processors, to transmit the sidelink communication in accordance with the configuration information, are configured to transmit, to the receiving UE, the sidelink communication in accordance with each PSFCH resource of the plurality of PSFCH resources associated with the carrier aggregation operation having the same time domain location across all component carriers of the plurality of component carriers, and in accordance with each bandwidth part of the plurality of bandwidth parts associated with the carrier aggregation operation having the same sidelink symbol length and the same sidelink start symbol.

3. The transmitting UE of claim 1, wherein each component carrier of the plurality of component carriers is associated with a same direct frame number and a same direct frame number offset.

4. The transmitting UE of claim 1, wherein each bandwidth part of the plurality of bandwidth parts is associated with a same orthogonal frequency-division multiplexing numerology.

5. The transmitting UE of claim 1, wherein each component carrier of the plurality of component carriers is configured with a same resource pool bitmap and a same PSFCH periodicity.

6. The transmitting UE of claim 1, wherein at least two component carriers of the plurality of component carriers are configured with different resource pool bitmaps and different PSFCH periodicities, and wherein each PSFCH resource of the plurality of PSFCH resources associated with the carrier aggregation operation has the same time domain location across all component carriers of the plurality of component carriers in accordance with a resource pool bitmap and a PSFCH periodicity indicating that each PSFCH resource of the plurality of PSFCH resources is to have the same time domain location across all component carriers of the plurality of component carriers.

7. The transmitting UE of claim 1, wherein a resource pool configuration to be used for transmitting the sidelink communication is configured per bandwidth part of the plurality of bandwidth parts.

8. The transmitting UE of claim 7, wherein the resource pool configuration includes a first transmission resource pool configured for carrier aggregation operation communications and a second transmission resource pool configured for non-carrier-aggregation-operation communications.

9. The transmitting UE of claim 7, wherein a transmission resource pool configured for carrier aggregation operation communications is configured for each bandwidth part combination of a plurality of bandwidth part combinations associated with the plurality of bandwidth parts.

10. The transmitting UE of claim 9, wherein each bandwidth part combination of the plurality of bandwidth part combinations is associated with one or more bandwidth part identifiers, wherein each bandwidth part identifier of a plurality of bandwidth part identifiers is associated with one or more sidelink resource pool bitmap identifiers and a PSFCH periodicity indicator.

11. The transmitting UE of claim 7, wherein the one or more processors are further configured to obtain an indication of the resource pool configuration from a memory of the transmitting UE.

12. The transmitting UE of claim 7, wherein the one or more processors are further configured to receive, from a network node, an indication of the resource pool configuration.

13. The transmitting UE of claim 1, wherein the carrier aggregation operation is an intra-band carrier aggregation operation.

14. A method of wireless communication performed by a transmitting user equipment (UE), comprising:
obtaining configuration information associated with a sidelink communication, the configuration information indicating that each physical sidelink feedback channel (PSFCH) resource of a plurality of PSFCH resources associated with a carrier aggregation operation is to have a same time domain location across all component carriers of a plurality of component carriers, and indicating that each bandwidth part of a plurality of bandwidth parts associated with the carrier aggregation operation is to be configured with a same sidelink symbol length and a same sidelink start symbol; and
transmitting, to a receiving UE, a sidelink communication in accordance with the configuration information.

15. The method of claim 14, wherein transmitting the sidelink communication in accordance with the configuration information comprises transmitting, to the receiving UE, the sidelink communication in accordance with each PSFCH resource of the plurality of PSFCH resources associated with the carrier aggregation operation having the same time domain location across all component carriers of the plurality of component carriers, and in accordance with each bandwidth part of the plurality of bandwidth parts associated with the carrier aggregation operation having the same sidelink symbol length and the same sidelink start symbol.

16. The method of claim 14, wherein each component carrier of the plurality of component carriers is associated with a same direct frame number and a same direct frame number offset.

17. The method of claim 14, wherein at least two component carriers of the plurality of component carriers are configured with different resource pool bitmaps and different PSFCH periodicities, and wherein each PSFCH resource of the plurality of PSFCH resources associated with the carrier aggregation operation has the same time domain location across all component carriers of the plurality of component carriers in accordance with a resource pool bitmap and a PSFCH periodicity indicating that each PSFCH resource of the plurality of PSFCH resources is to have the same time domain location across all component carriers of the plurality of component carriers.

18. The method of claim 14, wherein a resource pool configuration to be used for transmitting the sidelink communication is configured per bandwidth part of the plurality of bandwidth parts.

19. The method of claim 18, further comprising obtaining an indication of the resource pool configuration from a memory of the transmitting UE, or receiving, from a network node, the indication of the resource pool configuration.

20. An apparatus for wireless communication, comprising:
means for obtaining configuration information associated with a sidelink communication, the configuration information indicating that each physical sidelink feedback channel (PSFCH) resource of a plurality of PSFCH resources associated with a carrier aggregation operation is to have a same time domain location across all component carriers of a plurality of component carriers, and indicating that each bandwidth part of a plurality of bandwidth parts associated with the carrier aggregation operation is to be configured with a same sidelink symbol length and a same sidelink start symbol; and
means for transmitting, to a receiving UE, a sidelink communication in accordance with the configuration information.
